(19) United States
(12) Patent Application Publication
(10) Pub. No.: US 2024/0304826 A1
(43) Pub. Date: Sep. 12, 2024

(54) ELECTROLYTE MEMBRANE FOR MEMBRANE-ELECTRODE ASSEMBLY AND METHOD OF MANUFACTURING SAME

(71) Applicants: HYUNDAI MOTOR COMPANY, SEOUL (KR); KIA CORPORATION, SEOUL (KR); KOREA ADVANCED INSTITUTE OF SCIENCE AND TECHNOLOGY, DAEJEON (KR)

(72) Inventors: In Yu Park, Seoul (KR); Jong Kil Oh, Yongin-si (KR); Woo Chul Jung, Daejeon (KR); Seung Hyun Kim, Daejeon (KR); Dong Hwan Oh, Daejeon (KR)

(21) Appl. No.: 18/514,109

(22) Filed: Nov. 20, 2023

(30) Foreign Application Priority Data
Mar. 8, 2023 (KR) 10-2023-0030290

(51) Int. Cl. H01M 4/88; H01M 4/90; H01M 4/92

(52) U.S. Cl. CPC H01M 4/8892; H01M 4/8817; H01M 4/9016; H01M 4/92

(57) ABSTRACT

A highly durable electrolyte membrane using cerium oxide supported with an alloy catalyst that is a hydrogen-oxygen reaction catalyst for improving chemical durability of an electrolyte membrane increases durability of a membrane-electrode assembly including the same and decreases the manufacturing cost thereof.

### CROSS REFERENCE TO RELATED APPLICATIONS

This application claims, under 35 U.S.C. § 119(a), the benefit of priority from Korean Patent Application No. 10-2023-0030290, filed on Mar. 8, 2023, the entire contents of which are incorporated herein by reference.

### BACKGROUND

### (a) Technical Field

The present disclosure relates to an electrolyte membrane for a membrane-electrode assembly and a method of manufacturing the same, and more particularly to an electrolyte membrane for a membrane-electrode assembly and a method of manufacturing the same, in which durability of a membrane-electrode assembly is greatly increased using cerium oxide supported with an alloy catalyst in order to improve chemical durability of an electrolyte membrane.

### (b) Background Art

A polymer electrolyte membrane fuel cell for automobiles is a power generator that produces electric power through electrochemical reaction between hydrogen and oxygen in the air, and is well known as an eco-friendly next-generation energy source with high power generation efficiency and no emissions other than water. Moreover, a polymer electrolyte membrane fuel cell may typically operate at a temperature of 95° C. or less and may obtain high power density.

The reaction for generating electric power in the fuel cell occurs in a membrane-electrode assembly (MEA) configured to include a perfluorinated sulfonic acid ionomer-based membrane and electrodes including an anode and a cathode. Hydrogen supplied to the anode, which is the oxidizing electrode of the fuel cell, is separated into protons and electrons, after which the protons move toward the cathode, which is the reducing electrode, through the membrane, and the electrons move to the cathode through an external circuit, whereby oxygen molecules, protons, and electrons react together at the cathode to generate electric power and heat, and at the same time water (H₂O) is generated as a reaction byproduct.

In general, hydrogen and oxygen in the air, which are reactive gases of a fuel cell, crossover through an electrolyte membrane to promote production of hydrogen peroxide (HOOH), and this hydrogen peroxide generates oxygen-containing radicals such as hydroxyl radicals (·OH) and hydroperoxyl radicals (·OOH). These radicals attack the perfluorinated sulfonic acid-based electrolyte membrane, causing chemical degradation of the membrane and eventually having an adverse effect of reducing durability of the fuel cell.

Conventionally, in order to mitigate the chemical degradation of the electrolyte membrane, methods of adding various types of antioxidants to the electrolyte membrane have been devised.

The antioxidant includes a primary antioxidant functioning as a radical scavenger and a secondary antioxidant functioning as a hydrogen peroxide decomposer.

Examples of the primary antioxidant include cerium-based antioxidants such as cerium oxide, cerium (III) nitrate hexahydrate, etc., terephthalic acid-based antioxidants, and the like. Examples of the secondary antioxidant include antioxidants using noble metal catalysts such as platinum and manganese oxide.

With the goal of increasing the chemical durability of electrolyte membranes for fuel cells, thorough research into electrolyte membranes containing platinum has been carried out. Based on research results to date, the durability of the electrolyte membrane may be increased or decreased depending on the amount, degree of distribution, and microstructure of platinum introduced into the electrolyte membrane. As a positive effect, platinum introduced into the electrolyte membrane is capable of fundamentally suppressing generation of hydrogen peroxide and radicals by blocking hydrogen and oxygen that crossover through hydrogen-oxygen reaction for converting the hydrogen and oxygen gas that crossover into water before reaching the electrode, ultimately increasing durability of the electrolyte membrane. On the other hand, as a negative effect, production cost of the electrolyte membrane may remarkably increase due to application of an expensive platinum catalyst.

### SUMMARY

The present disclosure has been made keeping in mind the problems encountered in the related art, and an object of the present disclosure is to provide a highly durable electrolyte membrane using cerium oxide supported with an alloy catalyst that is a hydrogen-oxygen reaction catalyst for improving chemical durability of the electrolyte membrane, thereby increasing durability of a membrane-electrode assembly including the same and reducing the manufacturing cost.

The objects of the present disclosure are not limited to the foregoing. The objects of the present disclosure will be able to be clearly understood through the following description and to be realized by the means described in the claims and combinations thereof.

The present disclosure provides an electrolyte membrane for a membrane-electrode assembly including an ionomer having proton conductivity and a composite dispersed in the ionomer, in which the composite includes cerium oxide (CeOₓ) and an alloy catalyst supported on the cerium oxide, and the alloy catalyst includes an alloy of platinum and a metal other than platinum.

The cerium oxide may be in a form in which a (111) crystal plane is most exposed.

The cerium oxide may be a polyhedron and at least one of a surface or an inside of the polyhedron may be supported with the alloy catalyst.

The metal may include at least one selected from the group consisting of palladium (Pd), ruthenium (Ru), iridium (Ir), gold (Au), silver (Ag), chromium (Cr), manganese (Mn), iron (Fe), cobalt (Co), nickel (Ni), copper (Cu), molybdenum (Mo), yttrium (Y), and combinations thereof.

The composite may include, based on 100 parts by weight of the cerium oxide, 0.1 parts by weight to 10 parts by weight of the platinum and 0.1 parts by weight to 10 parts by weight of the metal.

The electrolyte membrane may include 1 μg/cm² to 30 μg/cm² of the composite.

The electrolyte membrane may include a reinforcement layer and an ion transport layer formed on at least one side of the reinforcement layer, in which the ion transport layer may include the ionomer and the composite.

The electrolyte membrane may include a reinforcement layer and ion transport layers formed on upper and lower sides of the reinforcement layer, in which one of the ion transport layers may not include the composite.

In addition, the present disclosure provides a method of manufacturing an electrolyte membrane for a membrane-electrode assembly including preparing cerium oxide doped with a metal element, preparing a composite by supporting platinum on the cerium oxide doped with the metal element, and manufacturing an electrolyte membrane by applying a mixture obtained by dispersing the composite in an ionomer.

Here, preparing the cerium oxide doped with the metal element may include stirring a cerium precursor and a metal precursor and heat-treating the result to obtain cerium oxide doped with a metal element.

The heat-treating may be performed at a temperature of 300° C. to 600° C. for 1 hour to 10 hours.

Also, preparing the composite may include subjecting a platinum precursor and the cerium oxide doped with the metal element to stirring, drying, and heat treatment and subjecting the result to reduction heat treatment to obtain a composite.

The drying may be performed at a temperature of 50° C. to 100° C., and the heat treatment may be performed at a temperature of 200° C. to 500° C. for 0.5 hours to 2 hours at a heating rate of 1° C./min to 5° C./min.

The reduction heat treatment may be performed at a temperature of 400° C. to 700° C. for 1 hour to 5 hours.

The catalyst may be supported by alloying the doped metal element with platinum supported on a surface of the cerium oxide due to exsolution to the surface of the cerium oxide through reduction heat treatment.

### BRIEF DESCRIPTION OF THE FIGURES

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 is a cross-sectional view showing an electrolyte membrane for a membrane-electrode assembly according to an embodiment of the present disclosure;

FIG. 2 shows a composite according to an embodiment of the present disclosure;

FIG. 3 is a TEM (transmission electron microscopy) image showing the surface of the composite according to an embodiment of the present disclosure;

FIG. 4 is a cross-sectional view showing an electrolyte membrane for a membrane-electrode assembly according to another embodiment of the present disclosure;

FIG. 5 is a flowchart schematically showing a process of manufacturing an electrolyte membrane for a membrane-electrode assembly according to the present disclosure; and

FIG. 6 shows results of testing hydrogen-oxygen reactivity of composites in Example and Comparative Example according to the present disclosure.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

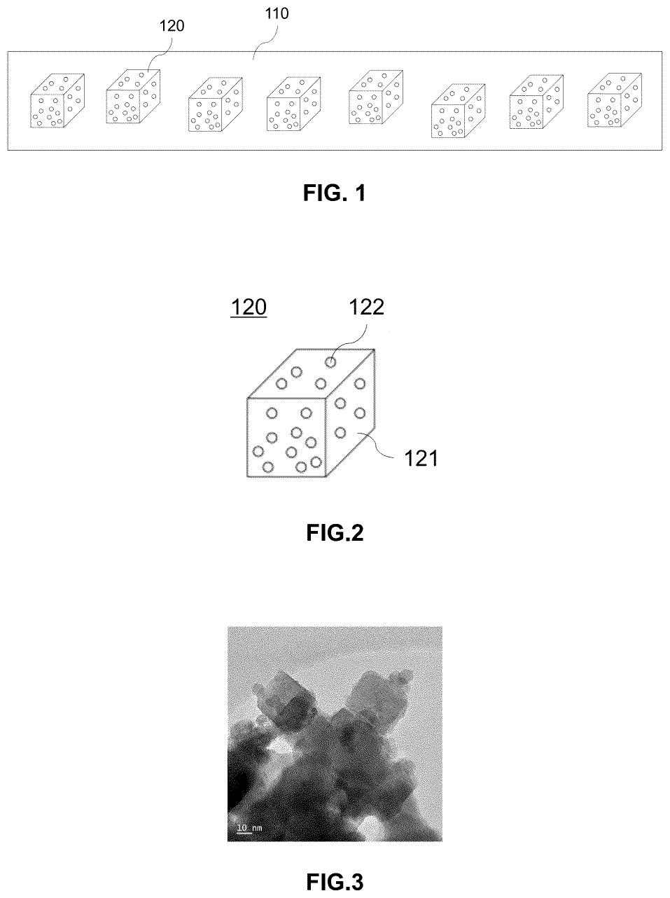

FIG. 1 is a cross-sectional view showing an electrolyte membrane for a membrane-electrode assembly according to an embodiment of the present disclosure. With reference thereto, the electrolyte membrane includes an ionomer 110 and a composite 120 dispersed in the ionomer 110.

The ionomer 110 serves as a kind of substrate forming the shape of the electrolyte membrane.

The ionomer 110 includes a material having proton conductivity. Accordingly, protons may move between a pair of electrodes formed on both sides of the electrolyte membrane. The ionomer 110 is not particularly limited, but may include at least one selected from the group consisting of perfluorinated sulfonic acid (PFSA), sulfonated poly(2,6-dimethyl-1,4-phenylene oxide) (SPPO), sulfonated polyethersulfone (SPES), sulfonated poly(ether ether ketone) (SPEEK), and combinations thereof, and may be, for example, a perfluorinated sulfonic acid ionomer (PFSA) such as Nafion, etc.

FIG. 2 shows a composite according to an embodiment of the present disclosure. With reference thereto, the composite 120 includes a cerium oxide (CeOₓ) 121 and an alloy catalyst 122 supported on the cerium oxide 121.

In the composite 120, the cerium oxide 121 may serve as a support for the alloy catalyst 122. Specifically, the cerium oxide 121 may contain the alloy catalyst 122 therein, or may contain the alloy catalyst 122 on at least a portion of the surface thereof.

The cerium oxide 121 is a representative radical scavenger and may function as an antioxidant.

The cerium oxide 121 may be in a form in which a (111) crystal plane is most exposed.

The cerium oxide may be a polyhedron, but is not limited thereto.

FIG. 3 is a TEM (transmission electron microscopy) image showing the surface of the composite according to an embodiment of the present disclosure. With reference thereto, the polyhedron may have a hexahedral cube shape.

At least one of a surface or an inside of the polyhedral cerium oxide 121 may be supported with the alloy catalyst 122.

The alloy catalyst 122 may include an alloy of platinum and a metal other than platinum. The metal may include at least one selected from the group consisting of palladium (Pd), ruthenium (Ru), iridium (Ir), gold (Au), silver (Ag), chromium (Cr), manganese (Mn), iron (Fe), cobalt (Co), nickel (Ni), copper (Cu), molybdenum (Mo), yttrium (Y), and combinations thereof, and may be, for example, ruthenium (Ru).

The composite 120 may include 0.1 parts by weight to 10 parts by weight of the platinum and 0.1 parts by weight to 10 parts by weight of the metal based on 100 parts by weight of the cerium oxide 121, preferably 0.5 parts by weight to 5 parts by weight of the platinum and 0.5 parts by weight to 5 parts by weight of the metal based on 100 parts by weight of the cerium oxide 121. If the amount of platinum or metal is less than 0.1 parts by weight, the function as a hydrogen-oxygen reaction catalyst may be very insufficient, whereas if it exceeds 10 parts by weight, catalyst cost may increase due to excessive use of noble metal.

The composite 120 may be included in an amount of 1 μg to 30 μg, preferably 5 μg to 20 μg per unit area (1 cm²) in the dried electrolyte membrane. If the amount of the composite is less than 1 μg/cm², hydrogen-oxygen reactivity may be insufficient, making it difficult to achieve desired effects, whereas if it exceeds 30 μg/cm², cost may increase due to excessive noble metal content.

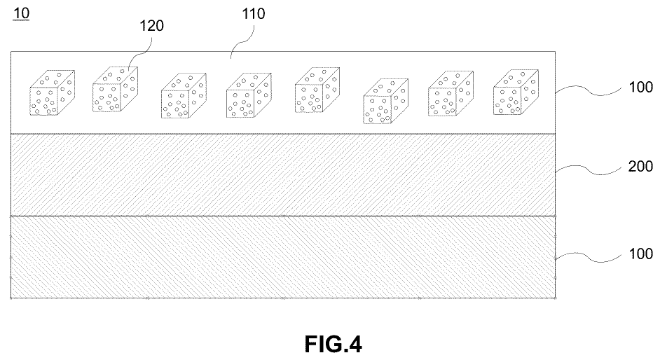

FIG. 4 is a cross-sectional view showing an electrolyte membrane 10 for a membrane-electrode assembly according to another embodiment of the present disclosure. The electrolyte membrane 10 may include a reinforcement layer 200 and an ion transport layer 100 formed on at least one side of the reinforcement layer 200, the ion transport layer 100 including the ionomer 110 and the composite 120. Alternatively, the electrolyte membrane 10 may include a reinforcement layer 200 and ion transport layers 100 formed on upper and lower sides of the reinforcement layer 200, one of the ion transport layers 100 not including the composite 120.

The ion transport layer 100 in each case may further include at least one selected from the group consisting of cerium-based oxide, manganese-based oxide, and combinations thereof, which are primary antioxidants that are materials having radical scavenging capability.

The reinforcement layer 200 is configured to increase mechanical strength of the electrolyte membrane. The reinforcement layer 200 is a porous film including a plurality of pores therein, and may be impregnated with the ionomer 110.

The reinforcement layer 200 may include at least one selected from the group consisting of polytetrafluoroethylene (PTFE), expanded polytetrafluoroethylene (e-PTFE), polyethylene (PE), polypropylene (PP), polyphenylene oxide (PPO), polybenzimidazole (PBI), polyimide (PI), polyvinylidene fluoride (PVdF), polyvinyl chloride (PVC), and combinations thereof.

Since the ionomer 110 and the composite 120 included in the ion transport layer 200 are as described above, a description thereof is omitted below.

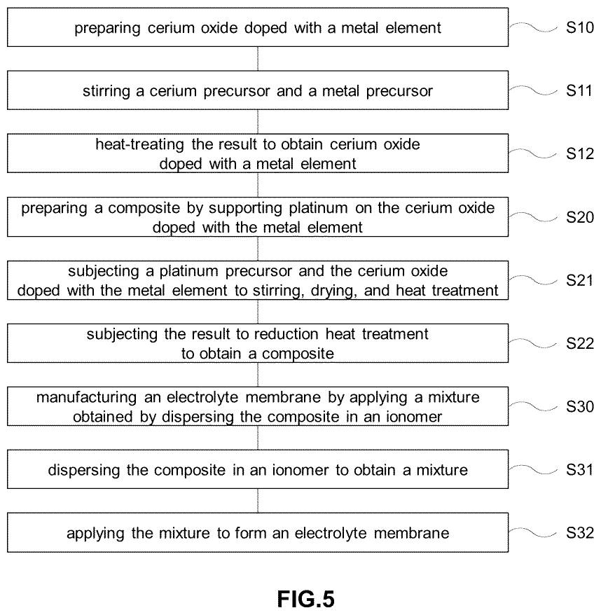

FIG. 5 is a flowchart schematically showing a process of manufacturing an electrolyte membrane for a membrane-electrode assembly according to the present disclosure. The method of manufacturing an electrolyte membrane for a membrane-electrode assembly according to the present disclosure may include preparing cerium oxide doped with a metal element at S10, preparing a composite by supporting platinum on the cerium oxide doped with the metal element at S20, and manufacturing an electrolyte membrane by applying a mixture obtained by dispersing the composite in an ionomer at S30. Here, the ionomer and the composite are as described above, and thus a description thereof is omitted below.

S10 may include stirring a cerium precursor and a metal precursor at S11 and heat-treating the result to obtain cerium oxide doped with a metal element at S12.

Conventionally, a method of supporting platinum and a metal on already-synthesized cerium oxide has been performed, but in the present disclosure, a metal precursor is added during preparation of cerium oxide to dope a polyhedral structure, for example, a cube structure of cerium oxide with a metal element.

The cerium precursor may include cerium nitrate hexahydrate (Ce(NO₃)₃·6H₂O).

The metal precursor may include ruthenium chloride n-hydrate (RuCl₃·nH₂O).

In S11, for example, the cerium precursor and the metal precursor may be dissolved at a ratio of 40:0.1-5 in 10 to 100 mL of deionized water, and 0.1-1 mol of sodium hydroxide (NaOH) may be mixed with 30 mL of deionized water, after which these two solutions may be mixed and allowed to react at 10 to 200° C. for 20 to 30 hours in a hydrothermal synthesis manner to obtain a precipitate.

In S12, for example, the precipitate obtained in S11 may be filtered and washed with deionized water three to seven times, followed by drying and then heat treatment at a temperature of 300 to 600° C. for 1 to 10 hours in an ambient atmosphere, thereby synthesizing cerium oxide doped with a metal element.

Here, the doping weight percentage of the metal element in the cerium oxide lattice is preferably 0.1 to 10 parts by weight, more preferably 0.5 to 5 parts by weight based on 100 parts by weight of cerium oxide. If the doping weight percentage thereof is less than 0.1 parts by weight, the function as a hydrogen-oxygen reaction catalyst may be very insufficient, whereas if it exceeds 10 parts by weight, catalyst cost may increase due to excessive use of noble metal.

Also, the heat treatment is preferably performed at 300° C. to 600° C. If the heat treatment temperature is lower than 300° C., it may be difficult to obtain a cerium oxide structure doped with a metal element, whereas if it is higher than 600° C., it may be difficult to obtain uniform dispersion properties due to bonding between cubic cerium oxides.

S20 may include subjecting a platinum precursor and the cerium oxide doped with the metal element to stirring, drying, and heat treatment at S21 and subjecting the result to reduction heat treatment to obtain a composite at S22.

The platinum precursor may include chloroplatinic acid (H₂PtCl₆).

In S21, for example, the result of S10 and the platinum precursor are added to deionized water and stirred. Here, the amount of platinum is 0.1 to 10 parts by weight based on 100 parts by weight of cerium oxide. After ultrasonic dispersion for 1 to 60 minutes, drying may be performed in an oven at 50 to 100° C. The dried powder may be subjected to heat treatment at a temperature of 200 to 500° C. for 0.5 to 2 hours in an ambient atmosphere. Here, the heating rate may be set to 1 to 5° C./min.

As such, the amount of platinum that is supported (supported weight) is preferably 0.1 to 10 parts by weight, more preferably 0.5 to 5 parts by weight, based on 100 parts by weight of cerium oxide. If the amount thereof is less than 0.1 parts by weight, the function as a hydrogen-oxygen reaction catalyst may be very insufficient, whereas if it exceeds 10 parts by weight, catalyst cost may increase due to excessive use of noble metal.

Also, the heating rate is preferably 1 to 5° C./min. If the heating rate is less than 1° C./min, productivity may decrease due to excessive processing time, whereas if it exceeds 5° C./min, platinum particles may not be formed in a uniform nano-scale but may clump together, making it difficult to achieve nano-homogenization of the particles.

In S22, for example, a composite including platinum-ruthenium-supported cerium oxide may be prepared by subjecting the result of S21 to reduction heat treatment at a temperature of 400 to 700° C. for 1 to 5 hours in a hydrogen atmosphere.

The reduction heat treatment may be performed at a temperature of 400° C. to 700° C. If the reduction heat treatment temperature is lower than 400° C., alloying with platinum due to exsolution of the metal element doped in the cerium oxide lattice to the surface of cerium oxide may become difficult, whereas if it is higher than 700° C., catalytic properties may be deteriorated due to coarse alloy catalyst particles.

For the composite prepared in the present disclosure, the metal is doped in the cerium oxide lattice, and platinum is formed in a nano-scale on the surface of cerium oxide, followed by reduction heat treatment, resulting in exsolution of the doped metal to the surface of cerium oxide particles, thereby forming an alloy catalyst on the surface of cerium oxide. When the composite is prepared in this way, hydrogen-oxygen reaction efficiency may be increased, and acid resistance to metal may be improved.

S30 may include dispersing the composite in an ionomer to obtain a mixture at S31 and applying the mixture to form an electrolyte membrane at S32.

In S31, for example, an ionomer dispersion solution (solid content of 1 to 30 wt %) dispersed in a mixed solvent of distilled water and alcohol is prepared, and a predetermined amount of the composite prepared in S20 is added thereto, followed by mixing using a magnetic bar for 10 to 300 minutes, preferably for 30 to 120 minutes. If the mixing time is less than 10 minutes, the dispersing effect may be very low, making it difficult to obtain sufficient dispersibility, whereas if the mixing time exceeds 300 minutes, processability may be deteriorated due to excessively long processing time.

Here, the amount of the composite may be 1 to 30 μg, preferably 5 μg to 20 μg per unit area (1 cm²) in the dried electrolyte membrane. If the amount of the composite is less than 1 μg/cm², hydrogen-oxygen reactivity may be insufficient, making it difficult to achieve desired effects, whereas if it exceeds 30 μg/cm², cost may increase due to excessive noble metal content.

In S32, the application process is not particularly limited, and any coating and drying processes commonly used in the field of fuel cells may be applied. For example, a bar coater may be used.

The electrolyte membrane may include a reinforcement layer for increasing mechanical strength, the type of which is not particularly limited. Also, the electrolyte membrane may include the aforementioned reinforcement layer and an ion transport layer formed on at least one side of the reinforcement layer by applying a mixture obtained by dispersing the composite in the ionomer. Here, the mixture including the composite may be applied only on either side of the reinforcement layer.

The manufacturing method may further include attaching an anode and a cathode to respective sides of the electrolyte membrane manufactured in S30 (S40), after S30.

S40 may be performed without limitation through any assembly process to manufacture a membrane-electrode assembly in the field of fuel cells.

A better understanding of the present disclosure may be obtained through the following example and comparative example. However, these examples are not to be construed as limiting the technical spirit of the present disclosure.

### EXAMPLE

Cerium nitrate hexahydrate ((Ce(NO₃)₃·6H₂O) serving as a cerium precursor and ruthenium chloride n-hydrate (RuCl₃·nH₂O) serving as a ruthenium precursor were dissolved at a ratio of 40:1 in 40 mL of deionized water. Separately, 0.5 mol of sodium hydroxide (NaOH) was mixed with 30 mL of deionized water. These two solutions were mixed and allowed to react at 100° C. for 24 hours in a hydrothermal synthesis manner. Thereafter, the resulting precipitate was filtered and washed with deionized water five times, followed by drying and then heat treatment at 500° C. for 4 hours in an ambient atmosphere, thereby synthesizing cerium oxide doped with ruthenium.

### Preparation of Composite

In order to further support platinum, chloroplatinic acid (H₂PtCl₆) serving as a platinum precursor and the cerium oxide doped with ruthenium were mixed with deionized water. Here, the amount of platinum was 1 wt % based on the final weight of cerium oxide. Then, ultrasonic dispersion for 10 minutes and then sufficient drying in an oven at 80° C. were performed. The dried powder was subjected to heat treatment at 400° C. for 1 hour in an ambient atmosphere. Here, the heating rate was set to 1° C./min.

The platinum-supported ruthenium-doped cerium oxide powder was subjected to reduction heat treatment at 600° C. for 3 hours in a hydrogen atmosphere, thereby forming a platinum-ruthenium-supported cerium oxide composite. Preferably, reduction heat treatment was performed at 400° C. to 700° C.

### Comparative Example

In Comparative Example, cerium oxide was first formed, after which ruthenium chloride n-hydrate (RuCl₃·nH₂O) serving as a ruthenium precursor, chloroplatinic acid (H₂PtCl₆) serving as a platinum precursor, and the cerium oxide formed above were mixed with deionized water. Here, the amounts thereof were the same as in Example. The mixture was ultrasonically dispersed for 10 minutes and then sufficiently dried in an oven at 80° C.

The dried powder was subjected to heat treatment at 400° C. for 1 hour in an ambient atmosphere. Here, the heating rate was set to 1° C./min.

The platinum-ruthenium-supported cerium oxide powder was subjected to reduction heat treatment at 600° C. for 3 hours in a hydrogen atmosphere in the same manner as in Example, thereby forming a platinum-ruthenium-supported cerium oxide ((Pt—Ru)/CeO₂-Im) composite in which both platinum and ruthenium were simultaneously supported on the surface of cerium oxide.

### Test Example 1: Hydrogen-Oxygen Reactivity Test

A hydrogen-oxygen reactivity test of the composites prepared in Example and Comparative Example was conducted. Differences between Example and Comparative Example are shown in Table 1 below.

TABLE 1

| | | Comparative |
|---|---|---|
| | Example | Example |
| Metal (ruthenium) | Exsolution through reduction heat | Surface |
| supporting method | treatment after doping in cerium | impregnation |
| | oxide | |
| Platinum supporting | Surface impregnation | Surface |
| method | | impregnation |

In the hydrogen-oxygen reactivity test, 25 mg of the catalyst was uniformly mixed with 100 mg of fine sand and placed in the center of a glass tube, and a hydrogen-oxygen gas mixture was allowed to flow from one side of the glass tube to the opposite direction of the glass tube using a carrier gas (argon). Here, the concentration of hydrogen in the gas mixture passed through the platinum-ruthenium-supported cerium oxide placed in the center of the glass tube was measured using a mass spectrometer (gas chromatography), and thus the ratio of the amount of hydrogen measured in the opposite direction relative to the amount of initially added hydrogen was determined, whereby hydrogen reaction efficiency (H₂ conversion ratio) depending on changes in reaction temperature was calculated.

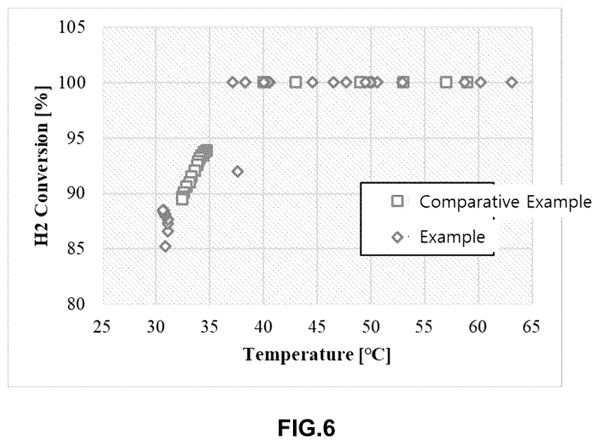

FIG. 6 shows results of testing hydrogen-oxygen reactivity of the composites in Example and Comparative Example according to the present disclosure. With reference thereto, based on results of the hydrogen-oxygen reactivity test of Example and Comparative Example, it can be found that both samples exhibited very high hydrogen-oxygen reactivity, and 100% hydrogen conversion ratio was recorded after about 40° C.

### Test Example 2: Acid Resistance Test

An acid resistance test of the composites prepared in Example and Comparative Example was conducted.

The acid resistance test was performed in a manner in which the catalyst of each of Comparative Example 1 and Example 1 was added in the same amount to 0.5 mol of sulfuric acid solution (H₂SO₄), followed by heating to 50° C. and reaction for 1 hour, whereby the amounts of platinum and ruthenium dissolved in the solution were measured by ICP-MS (inductively coupled plasma mass spectrometer). The results thereof are shown in Table 2 below.

TABLE 2

| | | Comparative | Comparative |
|---|---|---|---|
| | Example | Example | Example/Example |
| Dissolved Pt | 0.056% | 0.054% | 0.97 |
| Dissolved Ru | 0.0009% | 0.0021% | 2.33 |

With reference to Table 2, for platinum supported in the same manner in Example and Comparative Example, the amounts of dissolved platinum through acid resistance testing were approximately 0.056% and 0.054% of the initial weight, which are regarded as almost equal.

On the other hand, in Comparative Example in which ruthenium was supported through a general supporting method, the amount of dissolved ruthenium was 0.0021%, and in Example in which ruthenium was supported through exsolution after doping, the amount of dissolved ruthenium was 0.0009%. Thereby, the amount of dissolved ruthenium in Comparative Example was double or more that in Example.

Therefore, it can be found that acid resistance to ruthenium in Example was increased about 2.33-fold compared to Comparative Example.

As is apparent from the above description, an electrolyte membrane according to the present disclosure provides a membrane-electrode assembly in which chemical durability of the electrolyte membrane is greatly improved by virtue of cerium oxide supported with an alloy catalyst.

The effects of the present disclosure are not limited to the above-mentioned effects. It should be understood that the effects of the present disclosure include all effects that can be inferred from the description of the present disclosure.

Although specific embodiments of the present disclosure have been described, those skilled in the art will appreciate that the present disclosure may be embodied in other specific forms without changing the technical spirit or essential features thereof. Thus, the embodiments described above should be understood to be non-limiting and illustrative in every way.

1. An electrolyte membrane for a membrane-electrode assembly, comprising:
an ionomer having proton conductivity; and
a composite dispersed in the ionomer;
wherein the composite comprises cerium oxide (CeOₓ) and an alloy catalyst supported on the cerium oxide; and
wherein the alloy catalyst comprises an alloy of platinum and a metal other than platinum.

2. The electrolyte membrane of claim 1, wherein the cerium oxide is in a form in which a (111) crystal plane is most exposed.

3. The electrolyte membrane of claim 1, wherein the cerium oxide is a polyhedron, and wherein at least one of a surface or an inside of the polyhedron is supported with the alloy catalyst.

4. The electrolyte membrane of claim 1, wherein the metal other than platinum comprises at least one selected from the group consisting of: palladium (Pd), ruthenium (Ru), iridium (Ir), gold (Au), silver (Ag), chromium (Cr), manganese (Mn), iron (Fe), cobalt (Co), nickel (Ni), copper (Cu), molybdenum (Mo), yttrium (Y), and combinations thereof.

5. The electrolyte membrane of claim 1, wherein the composite comprises, based on 100 parts by weight of the cerium oxide, 0.1 parts by weight to 10 parts by weight of the platinum and 0.1 parts by weight to 10 parts by weight of the metal.

6. The electrolyte membrane of claim 1, wherein the composite is 1 μg/cm² to 30 μg/cm² based on a total amount of the electrolyte membrane.

7. The electrolyte membrane of claim 1, comprising a reinforcement layer and an ion transport layer formed on at least one side of the reinforcement layer, wherein the ion transport layer comprises the ionomer and the composite.

8. The electrolyte membrane of claim 1, comprising a reinforcement layer, a first ion transport layer formed on an upper side of the reinforcement later, and a second ion transport layer formed on a lower side of the reinforcement layer, wherein one of the first or second ion transport layer does not comprise the composite.

9. A method of manufacturing an electrolyte membrane for a membrane-electrode assembly, comprising:
preparing cerium oxide doped with a metal element;
preparing a composite by supporting platinum on the cerium oxide doped with the metal element; and
manufacturing an electrolyte membrane by applying a mixture obtained by dispersing the composite in an ionomer.

10. The method of claim 9, wherein the cerium oxide is in a polyhedron form in which a (111) crystal plane is most exposed.

11. The method of claim 9, wherein preparing the cerium oxide doped with the metal element comprises:
stirring a cerium precursor and a metal precursor; and
heat-treating a result to obtain cerium oxide doped with a metal element.

12. The method of claim 11, wherein the heat-treating is performed at a temperature of 300° C. to 600° C. for 1 hour to 10 hours.

13. The method of claim 9, wherein preparing the composite comprises:
subjecting a platinum precursor and the cerium oxide doped with the metal element to stirring, drying, and heat treatment; and
subjecting a result to reduction heat treatment to obtain a composite.

14. The method of claim 13, wherein the drying is performed at a temperature of 50° C. to 100° C., and the heat treatment is performed at a temperature of 200° C. to 500° C. for 0.5 hours to 2 hours at a heating rate of 1° C./min to 5° C./min.

15. The method of claim 13, wherein the reduction heat treatment is performed at a temperature of 400° C. to 700° C. for 1 hour to 5 hours.

16. The method of claim 13, wherein the composite in which an alloy catalyst is supported on a surface of the cerium oxide due to exsolution of the metal to the surface of the cerium oxide through the reduction heat treatment is provided.

17. The method of claim 9, wherein the composite comprises, based on 100 parts by weight of the cerium oxide, 0.1 parts by weight to 10 parts by weight of the platinum and 0.1 parts by weight to 10 parts by weight of the metal.

18. The method of claim 9, wherein the composite is 1 μg/cm² to 30 μg/cm² based on a total amount of the electrolyte membrane.

19. The method of claim 9, wherein the electrolyte membrane comprises a reinforcement layer and an ion transport layer formed on at least one side of the reinforcement layer by applying the mixture.

20. The method of claim 9, wherein the electrolyte membrane comprises a reinforcement layer, a first ion transport layer formed on an upper side of the reinforcement layer, and a second ion transport layer formed on a lower side of the reinforcement layer, wherein one of the first and second ion transport layers does not comprise the composite.
